(19) United States
(12) Patent Application Publication
(10) Pub. No.: US 2025/0252487 A1
(43) Pub. Date: Aug. 7, 2025

(54) SYSTEMS AND METHODS FOR PROPERTY MATCH DISPLAY AND EXECUTION

(71) Applicant: Wells Fargo Bank, N.A., San Francisco, CA (US)

(72) Inventors: Moses Harris, San Francisco, CA (US); Alan W. Hecht, Chanhassen, MN (US); Ramsay Huntley, San Francisco, CA (US); Placide Muhizi, San Francisco, CA (US); Judson Murchie, San Francisco, CA (US); Poonam Rao, San Francisco, CA (US); Nadia Van De Walle, San Francisco, CA (US)

(73) Assignee: Wells Fargo Bank, N.A., San Francisco, CA (US)

(21) Appl. No.: 18/430,514

(22) Filed: Feb. 1, 2024

(51) Int. Cl. G06Q 40/03; G06Q 50/16

(52) U.S. Cl. CPC G06Q 40/03; G06Q 50/16

(57) ABSTRACT

A system includes a processing circuit configured to receive transaction data of a person. The transaction data relates to a transaction associated with a category. The processing circuit is further configured to determine proximity parameters of the person. The proximity parameters correspond to a proximity to at least one merchant belonging to the category. The processing circuit is further configured to receive property data relating to real estate properties. The processing circuit is further configured to model the property data with the proximity parameters to generate property match data for the person. The property match data corresponds to at least one of the real estate properties that include the proximity to the at least one merchant belonging to the category associated with the transaction. The processing circuit is further configured to generate and provide, to a user device, an interface corresponding to the property match data.

### TECHNICAL FIELD

The present disclosure relates generally to the analysis of performance indicators of a user and making recommendations for acquisitions and for improving performance indicators related to the associated acquisitions.

### BACKGROUND

When looking to purchase a property, people typically have difficulty selecting a property that they can afford and that is accessible to services that they typically use, or a performance metric of the person falls below a threshold that a lender requires for certain products or rates.

### SUMMARY

Some arrangements relate to a system. In some arrangements, the system includes a processing circuit. In some arrangements, the processing circuit includes memory and one or more processors. In some arrangements, the processing circuit is configured to receive transaction data of a person. In some arrangements, the transaction data relates to a transaction associated with a category. In some arrangements, the processing circuit is also configured to determine, based on the transaction data, proximity parameters of the person. In some arrangements, the proximity parameters correspond to a proximity to at least one merchant belonging to the category associated with the transaction. In some arrangements, the processing circuit is also configured to receive property data relating to real estate properties. In some arrangements, the processing circuit is also configured to model the property data with the proximity parameters to generate property match data for the person. In some arrangements, the property match data corresponds to at least one of the real estate properties that include the proximity to the at least one merchant belonging to the category associated with the transaction. In some arrangements, the processing circuit is also configured to generate and provide, to a graphical user interface (GUI) of a user device, an interface corresponding to the property match data.

Some arrangements relate to a method. In some arrangements, the method includes receiving, by a processing circuit, transaction data of a person. In some arrangements, the transaction data relates to a transaction associated with a category. In some arrangements, the method also includes determining, based on the transaction data, proximity parameters of the person. In some arrangements, the proximity parameters correspond to a proximity to at least one merchant belonging to the category associated with the transaction. In some arrangements, the method also includes receiving property data relating to real estate properties. In some arrangements, the method also includes modeling the property data with the proximity parameters to generate property match data for the person. In some arrangements, the property match data corresponds to at least one of the real estate properties that include the proximity to the at least one merchant belonging to the category associated with the transaction. In some arrangements, the method also includes generating and providing, to a graphical user interface (GUI) of a user device, an interface corresponding to the property match data.

Some arrangements relate to a computer-readable storage medium (CRM) having instructions stored thereon that, when executed by a processing circuit, cause the processing circuit to perform operations. The operations include receiving, by the processing circuit, transaction data of a person. In some arrangements, the transaction data relates to a transaction associated with a category. In some arrangements, the operations also include receiving financial data of the person. In some arrangements, the financial data corresponds to financial factors of the person. In some arrangements, the operations also include determining, based on the transaction data, proximity parameters of the person. In some arrangements, the proximity parameters correspond to a proximity to at least one merchant belonging to the category associated with the transaction. In some arrangements, the operations also include determining, based on the financial data, financial parameters of the person. In some arrangements, the financial parameters correspond to a maximum property value the person can afford. In some arrangements, the operations also include receiving property data relating to real estate properties. In some arrangements, the operations also include modeling the property data with the proximity parameters and the financial parameters to generate the property match data for the person. In some arrangements, the property match data corresponds to at least one of the real estate properties that has a valuation less than the maximum property value and includes the proximity to the at least one merchant belonging to the category associated with the transaction. In some arrangements, the operations also include generating and providing, to a graphical user interface (GUI) of a user device, an interface corresponding to the property match data.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements. Numerous specific details are provided to impart a thorough understanding of embodiments of the subject matter of the present disclosure. The described features of the subject matter of the present disclosure may be combined in any suitable manner in one or more embodiments and/or implementations. In this regard, one or more features of an aspect of the invention may be combined with one or more features of a different aspect of the invention. Moreover, additional features may be recognized in certain embodiments and/or implementations that may not be present in all embodiments or implementations.

### BRIEF DESCRIPTION OF THE DRAWINGS

FIG. 1 is a block diagram of a computing environment including a property match system, according to example embodiments.

FIG. 2 is a block diagram illustrating an example computing system suitable for use in the example embodiments described herein.

FIG. 3 is a flow diagram of a method for displaying property match data, according to example embodiments.

FIG. 4 is an illustration of a configuration of a user interface generated by the property match system of FIG. 1, according to example embodiments.

FIG. 5 is an illustration of an additional configuration of a user interface generated by the property match system of FIG. 1, according to example embodiments.

FIG. 6 is an illustration of an additional configuration of a user interface generated by the property match system of FIG. 1, according to example embodiments.

FIG. 7 is an illustration of an additional configuration of a user interface generated by the property match system of FIG. 1, according to example embodiments.

FIG. 8 is an illustration of an additional configuration of a user interface generated by the property match system of FIG. 1, according to example embodiments.

FIG. 9 is an illustration of an additional configuration of a user interface generated by the property match system of FIG. 1, according to example embodiments.

FIG. 10 is an illustration of an additional configuration of a user interface generated by the property match system of FIG. 1, according to example embodiments.

### DETAILED DESCRIPTION

Referring generally to the figures, systems, and methods for displaying real estate properties that include a proximity to merchants belonging to a category associated with a transaction of a person are disclosed according to various embodiments herein. In some instances, the systems and methods provide property match indicators that indicate that the real estate properties include the proximity to the merchants belonging to the category associated with the transaction of the person, such that a user is made aware of the real estate properties that include the proximity to the merchants belonging to the categories. Additionally, in some instances, the systems and methods described herein include displaying real estate properties that are considered affordable to the person based on financial factors of the person.

In some instances, the systems and methods determine risks associated with the real estate properties. For example, in some instances, the systems and methods described herein may use data associated with the real estate properties to determine that the real estate properties are associated with an environmental risk or a social risk. The systems and methods described herein provide the risks associated with the real estate properties to the user, such that the user may consider the risks associated with the real estate properties when considering acquiring the real estate properties.

In some instances, the systems and methods receive an indication that the person has acquired a property and determine services related to the property. For example, in some instances, the systems and methods described herein may use data associated with the property to determine services associated with the property. The systems and methods described herein provide the services associated with the property to the user, such the user may register for the services.

In some instances, the systems and methods generate loan data related to one of the real estate properties included in the property match data and determine if the person qualifies for the loan. In some instances, if the person does not qualify for the loan, the systems and methods may generate suggestion data that includes a process for the person to qualify for the loan.

Accordingly, the systems and methods described herein provide a variety of improvements to over conventional computing systems. For example, conventional computing systems have not been configured to utilize categories of transactions of a person to determine which real estate properties are close to merchants belonging to the categories of the transactions. As such, a person may have difficulty determining which of the real estate properties are close to each of the merchants that the person may frequently visit. Further, even if the person found which of the real estate properties are close to each of the merchants that the person may frequently visit, conventional computing systems may have difficulty determining how the person may qualify for a loan associated with the real estate property if the person is denied the loan associated with the real estate property.

The systems and methods described herein solve these issues by providing users with property elements indicative of real estate properties that are close to merchants belonging to categories that are associated with transactions of the user, such that the user may easily determine which of the real estate properties are close (e.g., within a threshold distance) to the merchants that they may frequently visit. In some instances, the real estate properties may be provided to the user if the real estate properties are within a distance of the merchants belonging to the categories or if the real estate properties are within a travel time of the merchants belonging to the categories. Reducing the number of the real estate properties provided to the user to only the real estate properties close to the merchants belonging to the categories may ease the process of a person searching for real estate properties. In some instances, the property elements provided to the user may additionally be indicative of real estate properties that the person can afford, further narrowing the number of real estate properties that are presented to the user to ease the process of the person searching for the real estate properties. Additionally, if the person is denied a loan associated with one of the real estate properties, the person may be provided with steps that the person can take to qualify for the loan, clarifying the process that the person will need to follow in order to acquire one of the real estate properties.

Before turning to the figures, which illustrate certain example embodiments in detail, it should be understood that the present disclosure is not limited to the details or methodology set forth in the description or illustrated in the figures. It should also be understood that the terminology used herein is for the purpose of description only and should not be regarded as limiting.

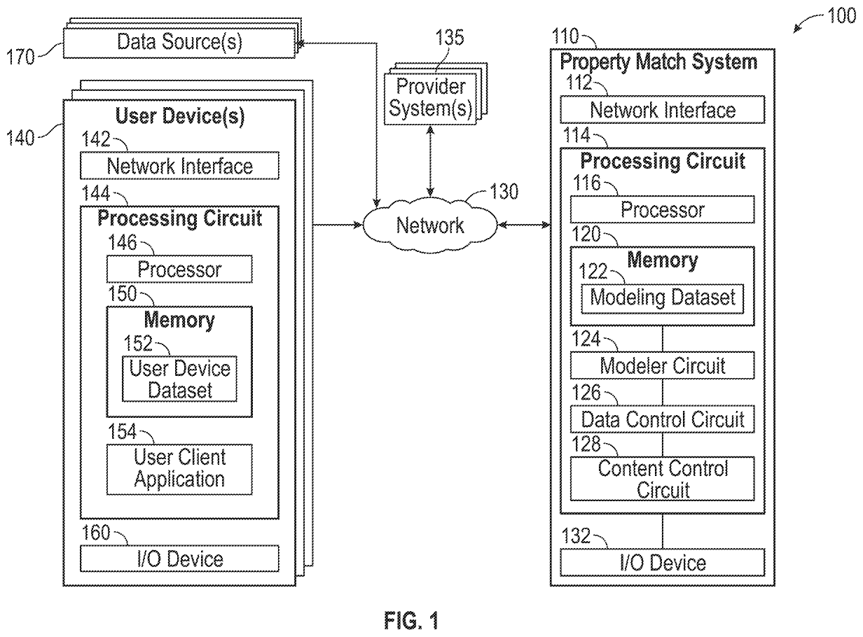

Referring to FIG. 1, a block diagram of a computing environment 100 including a property match system 110 is shown, according to potential embodiments. The property match system 110 can be associated with a provider, such as a service provider, bank, or financial institution (FI). The computing environment 100 further includes one or more user devices (e.g., user device 140), one or more data sources (e.g., data source 170), and one or more provider systems (e.g., the provider system 135). In some embodiments, the property match system 110, user device 140, and data source 170 are communicatively coupled. The various components of the computing environment are in communication with each other and are connected by a network 130.

Although the various systems and devices are shown in FIG. 1 as being singular, it will be understood that, in some instances, the computing environment 100 includes one or multiple of any of the various illustrated systems and/or devices, as desired for a given application. Similarly, while the following descriptions of the various systems and devices are largely provided in terms of single systems or devices, it will be appreciated that these descriptions are similarly applicable to any additional corresponding systems and/or devices (e.g., additional of the provider systems 135, additional of the user devices 140, and so on).

The property match system 110 may be operated by a provider, such as an entity, a consultant, a retailer, a service provider, and so on. The property match system 110 includes a network interface 112 that connects the property match system 110 to the network 130. The network interface 112 facilitates secure communications between the property match system 110 and various other components of the computing environment 100. The network interface 112 also facilitates communication with other entities (e.g., provider systems 135, etc.), such as other banks, healthcare systems, and so on. Further, in some arrangements, the network interface 112 includes cryptography capabilities to establish a secure or relatively secure communication session in which data communicated over the session is encrypted.

The processing circuit 114 includes a processor 116, a memory 120, a modeler circuit 124, a data control circuit 126, and a content control circuit 128. In other embodiments, the processing circuit 114 may contain more or less components than are shown in FIG. 1. The processor 116 may be implemented as one or more application specific integrated circuits (ASICs), field programmable gate arrays (FPGAs), a group of processing components, or other suitable electronic processing components. The memory 120 may be a device for storing data and/or computer code. The memory 120 may store data associated with a variety of application programs ran by the property match system 110. One such application may be to provide data to the modeler circuit 124, data control circuit 126, and content control circuit 128. The memory 120 can store a variety of data related to the modeler circuit 124 in a modeling dataset 122, which may be used by the modeler circuit 124 as discussed herein.

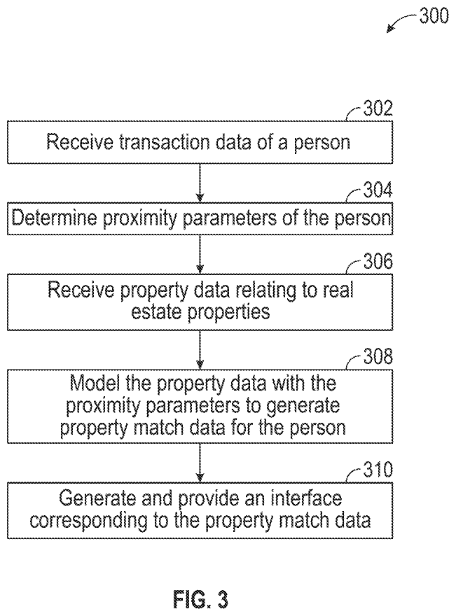

The modeler circuit 124 is structured or configured to perform a variety of the functionalities described herein. As will be described in detail below, with regard to FIG. 3, the modeler circuit 124 is configured to provide property match data to a user that is indicative of real estate properties that include a proximity to merchants belonging to categories associated with transactions of a person. As used herein, “proximity parameters” is used to refer to data, rules, and/or guidelines that may be used to determine which real estate properties include a proximity to merchants belonging to categories associated with transactions of the person. For example, if transaction data of a person includes multiple transactions relating to a public transportation service (e.g., a bus service, a train service, etc.), the proximity parameters may include a rule that real estate properties should be within half of a mile of a public transportation service. In some instances, the modeler circuit 124 is configured to provide property match data to the user that is indicative of real estate properties that have a valuation less than a maximum property value associated with financial factors (e.g., a credit score, an amount in a savings account, an income, a debt to income ratio, etc.) of the person. As used herein, “financial parameters” is used to refer to data, rules, and/or guidelines that may be used to determine which of the real estate properties are affordable to the person. For example, if financial data of a person includes a credit score below a first threshold and a savings amount that is below a second threshold, the financial parameters may include a rule that eliminates real estate properties that are valued above a maximum property value.

As will similarly be described below, in some instances, the modeler circuit 124 is further configured to provide an alert corresponding to a risk associated with a real estate property. In some instances, the modeler circuit 124 is additionally configured receive new property data relating to new real estate properties and determine which of the new real estate properties correspond to the transaction data and/or the financial data of the person. In some instances, the modeler circuit 124 is further configured to determine that the person has acquired a property and provide a notification corresponding to services related to the property. In some instances, the modeler circuit 124 is configured to provide suggestions that include steps for the person to qualify for a loan for one of the real estate properties. In some embodiments, the modeler circuit 124 is configured to notify the person that the person qualifies for the loan.

The data control circuit 126 is configured to fuse data, including operations to generate various data structures stored in the memory 120 and used by the various circuits described herein. The data control circuit 126 can also be configured to receive data from multiple sources (e.g., the data sources 170, the provider systems 135, the user devices 140, etc.) and aggregate the data into various data structures stored in the memory 120.

The content control circuit 128 is configured to generate content for displaying to users. The content can be selected from various resources (e.g., a request for a photograph of a real estate property from the data control circuit 126). The content control circuit 128 can also be structured to provide content (e.g., via a graphical user interface (GUI)) to the user device 140 over the network 130, for display. The content can also include actionable items that the user may select or otherwise manipulate. The content can be selected from various resources (e.g., from the data control circuit 126, from the memory 120, etc.).

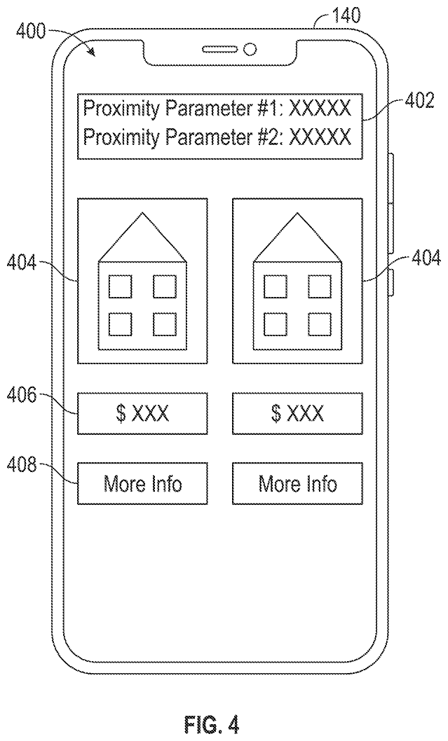

The content generated by the content control circuit 128 can include customized dashboards, such as those described in detail below, with reference to FIGS. 4-10. The content control circuit 128 can generate customized user-interactive dashboards for one or more entities, such as the user device 140, based on data received from the user device 140, data source 170, and/or any other computing device described therein. The generated dashboards can include various data (e.g., data stored in the content control circuit 128 and/or modeling dataset 122) associated with one or more real estate properties such as valuations, photographs or videos, descriptions, and/or others. In certain embodiments, the property match system 110 includes an application programming interface (API) and/or a software development kit (SDK) that facilitate the integration of other applications with the property match system 110. For example, the property match system 110 is configured to utilize the functionality of the user device 140 interacting through an API.

The content control circuit 128 can generate an interface corresponding to the property match data (e.g., generated by the modeler circuit 124). In some instances, the interface may include elements illustrating the real estate properties that include an accessibility to one or more of the lifestyle factors of the person. For example, the interface may include a first real estate property and a second real estate property that are associated with an element indicating that the first real estate property and the second real estate property are within a ten minute walk of a grocery store after determining that a person frequently visits grocery stores. In some instances, the interface may include elements illustrating the real estate properties that may be afforded by the person. For example, the interface may include a first real estate property that is associated with an element indicating that a person can afford the first real estate property.

The input/output device 132 is structured to receive communications from and provide communications to users associated with the property match system 110. The input/output device 132 can be structured to exchange data, communications, instructions, etc. with an input/output component of the property match system 110 (e.g., a mouse, a monitor, a keyboard, etc.). As such, the input/output device 132 may provide an interface for the user to interact with various applications stored on the property match system 110.

The user device 140 is owned, operated, controlled, and/or otherwise associated with a person (e.g., a person looking to acquire a real estate property, etc.). In some embodiments, the user device 140 may be or may include, for example, a desktop or laptop computer (e.g., a tablet computer), a smartphone, a wearable device (e.g., a smartwatch), a personal digital assistant, and/or any other suitable computing device. The user devices 140 may each include a network interface 142, a processing circuit 144, and an input/output device 160. The network interface 142, the processing circuit 144, and the input/output device 160 may be structured and function substantially similar to and include the same or similar components as the network interface 112, the processing circuit 114, and the input/output device 132 described above, with reference to the property match system 110. Therefore, it should be understood that the description of the network interface 112, the processing circuit 114, and the input/output device 132 of the property match system 110 provided above may be similarly applied to the network interface 142, the processing circuit 144, and the input/output device 160 of each of the user devices 140. The network interface 142 may similarly facilitate secure communications between the user device 140 and various other components of the computing environment 100. The processing circuit 144 similarly includes a memory 150 and a processor 146. The memory 150 and the processor 146 are substantially similar to the memory 120 and the processor 116 described above. Accordingly, the user devices 140 are similarly configured to run a variety of application programs and store associated data in a database of the memory 150. The variety of application programs and associated data may be stored as user device dataset 152.

Additionally, processing circuit 144 of each of the user devices 140 may each store, in the memory 150, and execute (“run”) user client applications 154, such as an Internet browser presenting websites and/or applications provided or authorized by entities implementing or administering any of the computing systems in computing environment 100 to enable the user to perform or otherwise interact with various methods and operations described herein. For example, in some instances, the user client applications 154 comprise a provider client application (e.g., a financial institution banking application) provided by and at least partly supported by the property match system 110 and configured to enable various functionality described herein. In some instances, the user client applications 154 comprise a provider client application provided by and at least partly supported by the provider system 135 and configured to enable various functionality described herein.

In some instances, the user client application 154 is additionally coupled to various components within the computing environment 100 (e.g., the property match system 110, the provider system 135) via one or more application programming interfaces (APIs) and/or software development kits (SDKs) to integrate one or more features or services provided by the various components to enable the various methods and operations described herein. For example, in some instances, a provider client application provided to the user device 140 by the property match system 110 implements various functionality of the provider system 135 via one or more APIs and/or SDKs to allow for various functionality and/or information provided and/or stored by the provider system 135 to be utilized or otherwise implemented within the context of the provider client application.

Additionally, the user client application 154 is configured to output information to a display of user device 140 regarding information received from the property match system 110. For example, the user client application 154 is configured to communicate with a user interface to show graphics regarding content associated with a real estate property such as a photograph, or a video, a valuation, or a description. Further, a user response to a display of user device 140 regarding information from the property match system 110 can send a message, task, or instruction to the property match system 110 via the network 130 that allows for the modeling dataset 122, modeler circuit 124, data control circuit 126, and/or content control circuit 128 to be perform an update.

The data sources 170 can provide data to the property match system 110 and/or user device 140. In some arrangements, the data sources 170 can be structured to collect data from other devices on network 130 (e.g., user devices 140 and/or other third-party devices) and relay the collected data to the property match system 110 and/or user device 140. In some embodiments, the property match system 110 may request data associated with specific data stored in the data source (e.g., data sources 170). For example, in some arrangements, the data sources 170 can support a search or discovery engine for Internet-connected devices. The search or discover engine may provide data from other providers that, when used to update property data associated with a real estate property, will cause an update to the property match data for a person (e.g., property match data generated by the modeler circuit 124 based on property data and proximity parameters of a person, etc.). For example, the search or discover engine may provide data from other providers indicating that a bookstore within a proximity of a first real estate property has closed and proximity data of a person may indicate that the person frequently visits bookstores. The first real estate property may be removed from property match data associated with the person since the first real estate property is no longer proximate to the bookstore. As another example, the search or discover engine may provide data from other providers indicating that a valuation of a second real estate property has decreased below a maximum property value and financial data of a person may indicate that the person can afford a house below the maximum property value. The second real estate property may be added to property match data associated with the person since the second real estate property is now considered affordable to the person.

With reference again to FIG. 1, the provider system 135 is controlled by, managed by, owned by, and/or otherwise associated with a provider, such as a bank, a credit union, an appraiser, a health care institution, a governmental institution, or other institutions (e.g., credit card companies, financial institutions (FI), insurance institutions, etc.). In some embodiment, the provider system may, for example, comprise one or more servers, each with one or more processing circuits including one or more processors configured to execute instructions stored in one or more memory devices, send and receive data stored in the one or more memory devices, and perform other operations to implement the operations described herein associated with certain logic and/or processes depicted in the figures. In some instances, the provider system 135 includes and/or has various other devices communicably coupled thereto, such as, for example, desktop or laptop computers (e.g., tablet computers), smartphones, wearable devices (e.g., smartwatches), and/or other suitable devices.

The provider system 135 may also store various individual information, transaction data, financial data, property data, property match data, and various other information. In some instances, the provider system 135 is configured to retrieve and transmit various individual data stored within the provider system 135 to various components within the computing environment 100 to enable the various methods, functions, and processes described herein.

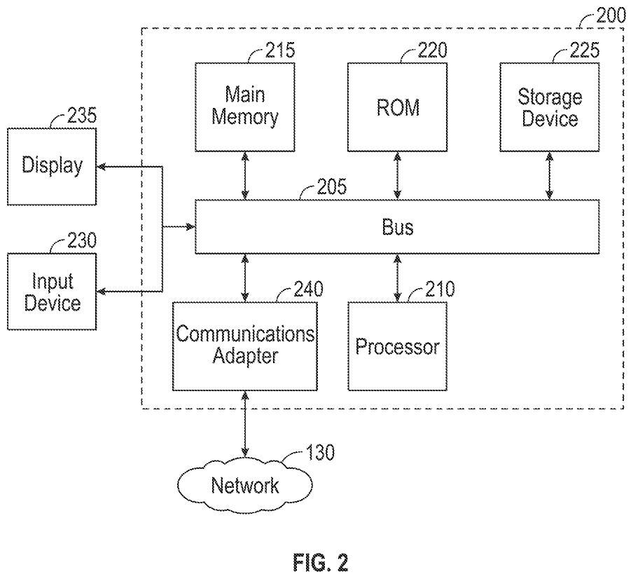

Referring now to FIG. 2, a depiction of a computing system 200 is shown. The computing system 200 can be used, for example, to implement the computing environment 100, the property match system 110, provider systems 135, user devices 140, data sources 170, and/or various other example systems described in the present disclosure. The computing system 200 includes a bus 205 or other communication component for communicating information and a processor 210 coupled to the bus 205 for processing information. The computing system 200 also includes main memory 215, such as a random-access memory (RAM) or other dynamic storage device, coupled to the bus 205 for storing information, and instructions to be executed by the processor 210. Main memory 215 can also be used for storing position information, temporary variables, or other intermediate information during execution of instructions by the processor 210. The computing system 200 may further include a read only memory (ROM) 220 or other static storage device coupled to the bus 205 for storing static information and instructions for the processor 210. A storage device 225, such as a solid-state device, magnetic disk, or optical disk, is coupled to the bus 205 for persistently storing information and instructions.

The computing system 200 may be coupled via the bus 205 to a display 235, such as a liquid crystal display, or active matrix display, for displaying information to a user. An input device 230, such as a keyboard including alphanumeric and other keys, may be coupled to the bus 205 for communicating information, and command selections to the processor 210. In some arrangements, the display 235 of the input device 230 has a touch screen. The input device 230 can include any type of biometric sensor, a cursor control, such as a mouse, a trackball, or cursor direction keys, for communicating direction information and command selections to the processor 210 and for controlling cursor movement on the display 235.

In some arrangements, the computing system 200 may include a communications adapter 240, such as a networking adapter. Communications adapter 240 may be coupled to bus 205 and may be configured to enable communications with the network 130 and/or other computing systems. In various illustrative arrangements, any type of networking configuration may be achieved using communications adapter 240, such as wired (e.g., via Ethernet), wireless (e.g., via Wi-Fi, Bluetooth), satellite (e.g., via GPS) pre-configured, ad-hoc, LAN, WAN.

According to various arrangements, the processes that effectuate illustrative arrangements that are described herein can be achieved by the computing system 200 in response to the processor 210 executing an arrangement of instructions contained in main memory 215. Such instructions can be read into main memory 215 from another computer-readable medium, such as the storage device 225. Execution of the arrangement of instructions contained in main memory 215 causes the computing system 200 to perform the illustrative processes described herein. One or more processors in a multi-processing arrangement may also be employed to execute the instructions contained in main memory 215. In alternative arrangements, hard-wired circuitry may be used in place of or in combination with software instructions to implement illustrative arrangements. Thus, arrangements are not limited to any specific combination of hardware circuitry and software.

Although an example processing system has been described in FIG. 2, arrangements of the subject matter and the functional operations described in this specification can be carried out using other types of digital electronic circuitry, or in computer software (e.g., application, blockchain, distributed ledger technology) embodied on a tangible medium, firmware, or hardware, including the structures disclosed in this specification and their structural equivalents, or in combinations of one or more of them. Arrangements of the subject matter described in this specification can be implemented as one or more computer programs, e.g., one or more subsystems of computer program instructions, encoded on one or more computer storage medium for execution by, or to control the operation of, data processing apparatus. Alternatively, or in addition, the program instructions can be encoded on an artificially generated propagated signal, e.g., a machine generated electrical, optical, or electromagnetic signal, that is generated to encode information for transmission to a suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices). Accordingly, the computer storage medium is both tangible and non-transitory.

Although shown in the arrangements of FIG. 2 as singular, stand-alone devices, one of ordinary skill in the art will appreciate that, in some arrangements, the computing system 200 may include virtualized systems and/or system resources. For example, in some arrangements, the computing system 200 may be a virtual switch, virtual router, virtual host, or virtual server. In various arrangements, computing system 200 may share physical storage, hardware, and other resources with other virtual machines. In some arrangements, virtual resources of the network 130 (e.g., network 130 of FIG. 1) may include cloud computing resources such that a virtual resource may rely on distributed processing across more than one physical processor, distributed memory, etc.

As used herein, the term “resource” refers to a physical or virtualized (for example, in cloud computing environments) computing resource needed to execute computer-based operations. Examples of computing resources include computing equipment or device (server, router, switch, etc.), storage, memory, executable (application, service, and the like), data file or data set (whether permanently stored or cached), and/or a combination thereof (for example, a set of computer-executable instructions stored in memory and executed by a processor, computer-readable media having data stored thereon, etc.).

With an example structure of the computing environment 100 being described above, example processes performable by the computing environment 100 (or components/systems thereof) will be described below. It should be appreciated that the following processes are provided as examples and are in no way meant to be limiting. Additionally, various method steps discussed herein may be performed in a different order or, in some instances, completely omitted. These variations have been contemplated and are within the scope of the present disclosure.

Referring now to FIG. 3, a flowchart for a method 300 of providing an interface that displays real estate properties that match preferences of a person based on transaction data of the person, according to some embodiments. Property match system 110 can be configured to perform method 300. Further, any computing device described herein can be configured to perform method 300. The GUI of method 300 may be provided by and/or accessible by the user client application 154 and content control circuit 128, for example. The method 300 may be performed by the property match system 110 or the user device 140, described above pertaining to FIGS. 1 & 2. In some embodiments, method 300 begins in response to receiving, by a user device (e.g., user device 140) and/or through a user client application (e.g., user client application 154), data from a dataset (e.g., user device dataset 152). The data can include transaction data including a transaction of the person or financial data relating to financial factors of the person. For example, in some instances, a user may initiate a property match analysis through a user device (e.g., the user device 140) by uploading transaction data relating to transactions of a person. In some embodiments, method 300 begins when the property match system 110 receives data via the network 130.

The method 300 begins with the processing circuit (e.g., property match system 110) receiving transaction data of a person, at step 302. The transaction data may relate to a transaction of the person and may include names of the transaction, valuations of the transaction, images associated with the transaction, or other information relating to the transaction. In some embodiments, the transaction may be related to a category. For example, a transaction associated with a pharmacy may be related to a medical category. In some instances, the transaction data may relate to multiple of the transactions associated with one of the categories. In some instances, the transaction data may relate to multiple of the transactions each associated with different of the categories. In some instances, the transaction data may relate to one of the transactions associated with multiple of the categories.

In some instances, the processing circuit may receive financial data of the person. The financial data may relate to financial factors of the person and may include names of the financial factors, valuations of the financial factors, images associated with the financial factors, or other information relating to the financial factors. For example, the financial factors may relate to a credit score of the person. As another example, the financial factors may relate to a net worth of the person.

Once the processing circuit has received the transaction data of the person, the processing circuit is configured to determine proximity parameters of the person, at step 304. In some instances, the proximity parameters may be determined based on the transaction data. In some instances, the proximity parameters may correspond to a proximity to at least one merchant belonging to at least one of the categories associated with the transactions. The proximity parameters may relate to data, rules, and/or guidelines that may be used to determine a proximity of a real estate property to a merchant belonging to a category. For example, the proximity parameters may relate to a rule that a real estate property be within a distance of a merchant belonging to a category, a rule that a real estate property be within a travel time away from a merchant belonging to a category, a rule that a real estate property be part of a same transportation network as a merchant belonging to a category, etc. For example, the transaction data of a person may relate to multiple transactions associated with an office supplies category. The processing circuit may determine a proximity parameter that a real estate property must be within a one mile radius of an office supplies store belonging to the office supplies category.

In some instances, the transaction data may include all of the information required to determine the proximity parameters or the modeler circuit 124 may need to receive additional transaction data from a different source (e.g., the provider system 135, the data source 170, etc.). For example, a user may request that a property match analysis be performed through the user interface of the user device 140 and may also upload transaction data relating to the transactions of the person. The transaction data uploaded by the user may include all of the transaction data required to perform the property match analysis or the modeler circuit 124 may need to receive additional transaction data from a different source (e.g., the provider system 135, the data source 170, etc.).

In some instances, the processing circuit may determine that a first of the proximity parameters of the person takes precedence over a second of the proximity parameters of the person. The processing circuit may determine that the first of the proximity parameters of the person takes precedence over the second of the proximity parameters of the person due to a first frequency of first transactions corresponding to the first of the proximity parameters being higher than a second frequency of second transactions corresponding to the second of the proximity parameters, first transactions corresponding to the first of the proximity parameters occurring more recently than second transactions corresponding to the second of the proximity parameters, a quantity of first transactions corresponding to the first of the proximity parameters being greater than a quantity of second transactions corresponding to the second of the proximity parameters, etc. For example, a health proximity parameter may correspond to a health merchant belonging to a health category and a grocery proximity parameter may correspond to a grocery merchant belonging to a grocery category. The transaction data of the person may indicate that the transactions of the person belong to the health category at a higher rate than the transactions belong to the grocery category. The processing circuitry may determine that the health proximity parameter takes precedence over the grocery proximity parameter due to the transactions belonging to the health category occurring at a higher rate than the transactions belonging to the grocery category.

In some instances, the processing circuit may provide the proximity parameters of multiple of the people to a civic organization (e.g., a local government, a city planner, etc.) for use in planning cities. For example, the proximity parameters may be provided to the civic organization so that the civic organization can determine the categories of merchants that are included in the proximity parameters that are not located in a city associated with the civic organization. The civic organization can then seek out merchants associated with the categories that are not located in the city to satisfy a missing desire for these merchants. For example, the proximity parameters of multiple people may include a requirement for a proximity to a coffee shop and a city may not contain a coffee shop. The proximity parameters may be provided to a city planning office of the city so that the city planning office can seek out a coffee shop that may become located in the city to satisfy the requirement for the coffee shop in the proximity parameters.

In some instances, the processing circuit may predict a category of a merchant that the person may require in the future based on the transactions included in the transaction data. In some instances, the prediction of the category of the merchant may be included in the proximity parameters. For example, a person may complete a transaction associated with a having a baby. The processing circuit may predict that the person will need day care services based on the transaction associated with having the baby. The processing circuit may include the day care services as a category in the proximity parameters such that the day care services that may be used to determine a proximity of a real estate property to a day care center belonging to the day care services category.

In some instances, the processing circuit may determine financial parameters of the person. In some instances, the financial parameters may be determined based on the financial data. In some instances, the financial parameters may correspond to a maximum property value that the person can afford. The financial parameters may relate to data, rules, and/or guidelines that may be used to determine a maximum property value of a real estate property that the person can afford. For example, the financial parameters may relate to a rule that a projected mortgage payment of a real estate property be less than a proportional amount of a monthly income of the person, a rule that the person may qualify for a loan for a real estate property, etc. For example, the financial data of a person may include a monthly income and a credit score. The processing circuit may determine a financial parameter that is a maximum property value that the person is able to afford based on the monthly income and the credit score.

Once the processing circuit has determined the proximity parameters of the person, the processing circuit is configured to receive property data relating to real estate properties, at step 306. The property data may relate to at least one real estate property and may include names of the real estate properties, valuations of the real estate properties, images associated with the real estate properties, addresses of the real estate properties, or other information relating to the real estate properties. In some instances, the real estate data may be received from the provider system 135 or the data source 170. For example, in some instances, the real estate data may be received from a third-party real estate valuation provider. In some instances, the property data may be restricted to a specific area. For example, a user may request that a property match analysis be performed through the user interface of the user device 140 for a specific city and the property data may be restricted to real estate properties within the specific city.

Once the processing circuit has received the property data and determined the proximity parameters, the processing circuit is configured to model the property data with the proximity parameters to generate property match data for the person, at step 308. The property match data may correspond to at least one of the real estate properties that include the proximity to the at least one merchant belonging to the category associated with the transaction. For example, the property data may include multiple of the real estate properties and the proximity parameters may include a parameter that indicates that a real estate property should include a proximity to a merchant belonging to a category associated with transactions of a person. The processing circuit can model the property data with the proximity parameters to generate property match data that includes a selection of the multiple of the real estate properties that include the proximity to the merchant belonging to the category. As another example, the property data may include a first house that is within a mile of a hospital and a second house that is not within a mile of a hospital. The proximity parameters may include a parameter that a real estate property should be within a mile of a hospital based on the transaction data including a least one transaction at a hospital. The processing circuit can model the property date with the proximity parameters to generate property match data that includes the first house due to the first house being within a mile of the hospital and the second house not being within a mile of the hospital.

In some instances, the processing circuit is configured to model the property data with the financial parameters to generate property match data for the person. The property match data may correspond to at least one of the real estate properties that has a projected value that is less than the maximum property value that the person can afford. For example, the property data may include multiple of the real estate properties and the financial parameters may include a parameter that indicates that a real estate property should have a projected value that is less than the maximum property value that the person can afford. The processing circuit can model the property data with the financial parameters to generate property match data that includes a selection of the multiple of the real estate properties that have a projected value that is less than the maximum property value that the person can afford. As another example, the property data may include a first house with a first projected value of $400,000 and a second house with a second projected value of $600,000. The proximity parameters may include a parameter that indicates that a real estate property should have a projected value that is less than $500,000. The processing circuit can model the property data with the financial parameters to generate property match data that includes the first house due to the first house having a projected value that is less than the maximum property value and the second house having a projected value that is greater than the maximum property value.

In various instances, the processing circuit is configured to model the property data with the proximity parameters and the financial parameters to generate property match data for the person. For example, the property match data may include multiple of the real estate properties, proximity parameters may include a parameter that indicates that a real estate property should include a proximity to a merchant belonging to a category associated with transactions of a person, and the financial parameters may include a parameter that indicates that a real estate property should have a projected value that is less than the maximum property value that the person can afford. The processing circuit can model the property data with the financial parameters to generate property match data that includes a selection of the multiple of the real estate properties that include the proximity to the merchant belonging to the category and that have a projected value that is less than the maximum property value that the person can afford.

In some instances, the process of modeling can include using techniques such as machine learning, statistical analysis, and pattern recognition to establish relationships between data and parameters and generate resulting data based on those relationships. In some embodiments, modeling can begin with the selection of an appropriate model based on the data and the parameters. It should be understood that the term modeling herein encompasses a wide range of techniques and approaches aimed at understanding relationships within data. This could include anything from statistical methods and rule-based systems to machine learning algorithms, depending on the nature of the data. Thus, modeling involves selecting techniques based on the specific characteristics of the data, ensuring that the chosen method or methods accurately captures relationships.

In some instances, the model parameters can be trained and optimized using the cleaned, classified, and linked data and parameters. This training process can include using algorithms to adjust the model parameters such that the error between the model's predictions and the actual outcomes is minimized. The modeling process can also include feature engineering, which is the process of creating new features or modifying existing ones to improve the model's power. For example, instead of determining proximity parameters corresponding to a proximity to a grocery store belonging to a grocery category associated with the transactions, a feature that ignores the transactions associated with the grocery category might result in a more efficient model due to the fact that most of the real estate properties include a proximity to a grocery store.

Once one or more models or techniques are trained and/or optimized, the processing circuits can use the model to generate resultant data. The resultant data could be a mathematical representation, a decision tree, a set of rules, or any other structure that captures the relationships between different data points. Moreover, the modeling process can include various safeguards to ensure privacy and security of user data (e.g., anonymizing the data).

In some embodiments, the processing circuits can use rule-based systems to model the data and the parameters. Rule-based systems can be where predefined rules are created by the processing circuits (or domain experts) to infer outcomes based on given conditions. For example, if a city does not have a public transportation network, a rule may state that that any proximity parameters corresponding to merchants belonging to a public transportation category should be ignored for real estate properties located within the city. This rule can be applied to the process to limit the process to modeling the data with parameters that do not correspond to the merchants belonging to the public transportation category.

In some instances, the processing circuit may be configured to determine that at least one of the real estate properties included in the property match data is associated with a risk. In some instances, the processing circuit may use the property data to determine that the at least one of the real estate properties included in the property match data is associated with the risk. In some instances, the processing circuit may determine that the real estate properties are associated with a risk of being affected by an environmental factor (e.g., a hurricane, a flood, a wildfire, etc.), a risk of being affected by a social factor (e.g., located in a high crime area, located in an area where property value is not projected to increase, etc.), etc. For example, the processing circuit may utilize the property data of a first apartment to determine that the first apartment is located on a first floor of a building in a flood zone. As another example, the processing circuit may utilize a location of a house contained within the property data to determine that the house is located in an area with higher crime than average. In some instances, the processing circuit may use the area codes of the real estate properties to determine that the real estate properties are associated with the risk.

In some instances, after the processing circuit has generated the property match data, the processing circuit can receive new or updated property data and/or proximity parameters. For example, the processing circuit may be configured to continuously monitor and receive new information (e.g., from the user device 140, from the data source 170, from the provider system 135, etc.) and determine the effect on the property match data. For example, the processing circuit can receive new or updated property data that includes houses that are newly built. New data can affect modeling results of the processing circuit modeling the property data with the proximity parameters, and there for the property match data. For example, the processing circuit may receive new property data relating to new real estate properties after the processing circuit has already modeled the property data with the proximity parameters. A source (e.g., user device 140, data source 170, or provider system 135) may send an update of the rule guiding the property match analysis to the processing circuit. Because updates to the proximity parameters can be a significant factor affecting the property match data, the processing circuit can model the new property data and the property data with the proximity parameters to generate an updated version of the property match data. In some embodiments, the processing circuit may notify the user of the updated version of the property match data (e.g., through the user device 140, through a notification of a change to the property data, etc.).

In some instances, the processing circuit can receive projected property data. For example, the processing circuit may be configured to continuously monitor and receive new information (e.g., from the user device 140, from the data source 170, from the provider system 135, etc.) and predict the effect on the property match data. For example, the processing circuit can receive projected property data reflecting an apartment building that is currently under construction or an upcoming vacancy in an apartment building. The projected property data can be added to the property data and affect modeling results of the processing circuit modeling the property data with the proximity parameters. For example, the processing circuit may receive the projected property data relating to real estate properties that will be available in the future and model the projected property data with the proximity data to generate projected property match data, where the projected property match data includes the real estate properties that will become available in the future that meet the requirements of the proximity parameters.

Once the processing circuit has generated the property match data corresponding to the real estate properties, the processing circuit may generate and provide an interface corresponding to the property match data, at step 310. The processing circuit may provide the interface to a graphical user interface (GUI) of a user device (e.g., the user client application 154 of the user device 140). The interface may include elements (e.g., text, videos, images, buttons, etc.) indicating the real estate properties included in the property match data. For example, the elements may be images of each of the real estate properties included in the property match data. In some instances, the elements of the interface may include an indication of the merchants belonging to the category associated with the transaction from the transaction data. In some instances, the processing circuit may be configured to update the interface corresponding to the property match data after receiving the new property data relating to the new real estate properties and modeling the new property data and the property data with the proximity parameters to generate the updated version of the property match data for the person.

In some embodiments, the processing circuit is configured to transfer an amount from a first account of the person into a property account associated with saving for at least one of the real estate properties included in the property match data. For example, the person may decide to purchase a home that is included in the property match data. The person may select an amount to contribute to a property account associated with the home. The processing circuit may be configured to notify the person once the property account includes an amount sufficient to purchase the account. In some instances, the processing circuit may be configured to restrict the person's access to the property account for a predetermined time period. For example, the processing circuit can restrict the person's access to the account for a number of years (e.g., five years, six years, seven years, etc.) until the person is able to purchase the at least one of the real estate properties included in the property match data.

In some instances, the processing circuit may generate and provide a recommendation interface corresponding recommendations to the person to assist the person with acquiring one of the real estate properties included in the property match data. In some instances, the recommendation interface may include financial guidance or financial planning to assist the person with acquiring the one of the real estate properties included in the property match data. For example, the recommendation interface may include text describing the process for saving up an amount that is sufficient to purchase a home included in the property match data.

In some instances, as described below, the processing circuit is configured to determine a recommended real estate property, such as a recommended house, using one or more machine learning models. Accordingly, in some instances, the interface may be arranged such that one of the elements indicating the recommended real estate property is displayed more prominently than the other of the elements indicating the other of the real estate property. For example, in some instances, the one of the elements the first real estate property may be bolded, underlined, enlarged, or moved to an uppermost location of the interface (i.e., the first choice). In some instances, upon the one or more machine learning models determining that the recommended real estate property for the user has changed, the processing circuit is configured to modify or update the interface provided to the GUI to rearrange or redesign the elements indicating the real estate property such that the new recommended real estate property is prominently displayed instead of the previous recommended real estate property.

Furthermore, in some instances, the elements indicating the real estate property shown within the interface provided to the GUI may be arranged within the interface based on their estimated relevance to the user. For example, in some instances, the processing circuit is configured to estimate the most relevant and/or beneficial of the real estate properties for inclusion within the interface using one or more machine learning models of the processing circuit. In some instances, the processing circuit may train the one or more machine learning models to identify the most relevant and/or beneficial of the real estate properties for inclusion using various training data. The training data may include historical acquisitions of similar real estate properties by users, and corresponding user information (e.g., income level, geographic location, transaction data, etc.) associated with those users. In some instances, the training data may be data compiled over time from a variety of users associated with the provider and stored within a database associated with the provider system 135.

Accordingly, once the one or more machine learning models have been trained, the processing circuit may apply the historical acquisition of the real estate properties by users and various user information pertaining to the user to the one or more machine learning models to identify the most relevant and/or beneficial of the real estate properties for inclusion on the interface provided to the GUI. The processing circuit may further arrange the elements indicating the real estate properties specifically according to their estimated relevance. For example, in some instances, the most relevant elements may be arranged in a top left corner of the interface. The elements may be arranged in descending order of relevance from left to right and top to bottom within the interface. In some instances, the processing circuit is configured to utilize various feedback information (e.g., real estate properties actually acquired by the user) received from the user (e.g., via the user device 140) to retrain or otherwise update the one or more machine learning models. Accordingly, in some instances, the processing circuit may rearrange the elements on the interface based on the updated machine learning models and their associated outputs.

In some instances, the processing circuit can receive an indication that the person has acquired a property. In some instances, the property may be one of the real estate properties included in the property match data. In some instances, a user may upload the indication that the person has acquired the property through a user device (e.g., the user device 140). In some instances, the processing circuit may receive the indication that the person has acquired the property from the data source 170 or the provider systems 135. For example, the processing circuit may receive an indication that the person has taken out a loan on the property from the provider system 135.

In some instances, the processing circuit can determine services relating to the property. In some instances, the processing circuit may determine the services relating to the property based on the property data. For example, the processing circuit may identity a location of the property based on the property data and may determine the services related to the property based on the location of the property. In some instances, the services relating to the property may include waste services, electric services, water services, gas services, etc. For example, the processing circuit may determine that the property is serviced by a refuse service company based on the location of the property or that the property is serviced by an electric service company based on the location of the property.

In some instances, the processing circuit can generate and provide a notification interface corresponding to the services relating to the property to the GUI of the user device (e.g., the user device 140). For example, after the processing circuit determines that the property is serviced by a refuse service company and the processing circuit may generate and provide a notification to the user device 140 that the person that acquired the property should sign up for a refuse service from the refuse service company. In some instances, the processing circuit may sign up the person who acquired the property for the service relating to the property after receiving an input from a user device. For example, the processing circuit may determine that a gas service relates to an apartment acquired by a person and after receiving a selection of an actionable activity from a user device, the processing circuit may register the person for the gas service. In some instances, the processing circuit may be configured to automatically sign up the person that acquired the property for a service relating to the property. For example, after the processing circuit determines that a house is serviced by an electric service company, the processing circuit may sign the person who acquired the house up for an electric service from the electric service company.

In some instances, the processing circuit can generate loan data corresponding to a loan related to at least one of the real estate properties included in the property match data. In some embodiments, the loan data may be generated based on the property data relating to the at least one of the real estate properties. For example, the loan data may include an amount and a term length associated with a loan for a house.

In some instances, the processing circuit can determine that the person does not qualify for the loan. In some instances, the processing circuit can determine that the person does not qualify for the loan based on the financial data and the loan data. In some instances, the processing circuit may determine that the person does not qualify for the loan based on an income of the person, based on a credit score of the person, based on a debt to income ratio of the person, etc. For example, the processing circuit can compare the financial data including financial attributes with the person with the amount and the term included in the loan data and determine that the person does not qualify for the loan. For example, the financial data of the person may include a credit score of 670 and the loan data may include a requirement for a credit score of at least 700. The processing circuit may determine that the person does not qualify for the loan based on the person having a credit score that is below 700.

In some instances, the processing circuit can model the financial data with the loan data to generate suggestion data. In some instances, suggestion data can include a process for the person to qualify for the loan. In some instances, the process may include reducing a debt to income ratio of the person, the person holding a job for a threshold amount of time, the person completing a threshold amount of education, etc. For example, the process for the person to qualify for the loan may include the person completing a college degree. As another example, the process for the person to qualify for the loan may include the person paying off an amount of debt to decrease the debt to income ration of the person below a threshold. Advantageously, the suggestion data may make clear to the person the process to qualify for the loan relating to the at least one of the real estate properties included in the property match data such that the person may follow the process to qualify for the loan and acquire the real estate property.

In some instances, the processing circuit may generate and provide a suggestion interface corresponding to the suggestion data. The processing circuit may provide the suggestion interface to the GUI of the user device and the suggestion interface may include a plurality of steps in the process to qualify for the loan. For example, the suggestion interface may include a list of steps for a person to perform in order for the person to qualify for a loan related to a real estate property.

In some instances, the processing circuit can determine that the person has completed at least one of the steps in the process for the person to qualify for the loan. In some instances, the processing circuit may determine that the person has completed the at least one of the steps in the process based on information received from the data source 170 or the provider system 135. For example, the provider system 135 may provide information to the processing circuit that the person has paid off an amount of debt. The processing circuit may determine, based on the amount of dept that the person paid off, that the person has completed the step in the process for the person to qualify for the loan relating to increasing the debt to income ration of the person above a threshold required to qualify for the loan. In some instances, the processing circuit may determine that the person has completed the at least one of the steps in the process based on information that a user has uploaded through a user device (e.g., the user device 140). For example, the user may upload an indication that the person has completed a college degree. The processing circuit may determine, based on the college degree, that the person has completed the step in the process for the person to qualify for the loan relating to completing a college degree.

In some instances, the processing circuit may update the suggestion interface corresponding to the determination that the person has completed at least one of the steps in the process for the person to qualify for the loan. For example, an element may be incorporated into the suggestion interface that indicates that the person has completed the at least one of the steps in the process for the person to qualify for the loan. For example, a checkmark may be incorporated into the suggestion interface next to the step in the list of steps for a person to perform in order for the person to qualify for a loan related to a real estate property.

In some instances, after the processing circuit has determined that the person has completed at least one of the steps in the process for the person to qualify for the loan, the processing circuit may receive an updated version of the financial data of the person. In some instances, the updated version of the financial data of the person may have been modified to reflect that the person has completed the at least one of the steps in the process for the person to qualify for the loan. For example, if the person has eliminated a portion of the debt of the person. the financial data of the person may be updated to reflect a lower debt to income ratio of the person.

In some instances, after the processing circuit has received the updated version of the financial data of the person, the processing circuit may determine that the person qualifies for the loan. In some instances, the processing circuit can determine that the person qualifies for the loan based on the updated version of the financial data and the loan data. In some instances, the processing circuit may determine that the person qualifies for the loan based on an income of the person, based on a credit score of the person, based on a debt to income ratio of the person, etc. For example, the processing circuit can compare the updated version of the financial data including financial attributes with the person with the amount and the term included in the loan data and determine that the person qualifies for the loan. For example, the updated version of the financial data of the person may include a credit score of 720 and the loan data may include a requirement for a credit score of at least 700. The processing circuit may determine that the person qualifies for the loan based on the person having a credit score that is above 700.

In some instances, once the processing circuit has determined that the person qualifies for the loan, the processing circuit may then generate and provide a notification interface. The processing circuit may provide the notification interface to a graphical user interface (GUI) of a user device (e.g., the user client application 154 of the user device 140). The interface may include elements (e.g., text, videos, images, buttons, etc.) indicating that the person qualifies for the loan. For example, the elements may include an approval notification indicating that the person has qualified for the loan (e.g., “Congratulations! You have qualified,” etc.) or a banner indicating that the person has successfully qualified for the loan.

In some instances, the circuit may register the person for the loan. For example, the processing circuit may determine that the person has qualified for the loan for one of the real estate properties included in the property match data and register the person for the loan. In some instances, the processing circuit may be configured to register the person for the loan after receiving a selection of an actionable activity from a user device. In some instances, the processing circuit may be configured to automatically register the person for the loan.

Referring now to FIG. 4, an illustration of a configuration of a user interface 400 on the user device 140 is shown. The user interface 400 may be presented within the user client application 154. In some embodiments, the user interface 400 is generated and provided by the content control circuit 128 and transmitted to the user device 140 to be displayed to a user.

As illustrated, the user interface 400 includes a plurality of proximity parameter indicators 402, a plurality of property elements 404, a plurality of property information elements 406, and a plurality of property actionable items 408. The proximity parameter indicators 402 may indicate each of the proximity parameters that are being used in a property match analysis. As illustrated, the proximity parameter indicators 402 are a text prompt indicating each of the proximity parameters that are considered in the property match analysis. In some instances, the proximity parameter indicators 402 may include figures indicating the proximity parameters, elements indicating the proximity parameters, etc. For example, if a first proximity parameter is related to a proximity to a merchant belonging to a health category, the proximity parameter indicator 402 may be an illustration of a red cross. As another example, if a second proximity parameter is related to a proximity to a merchant belonging to an air travel category, the proximity parameter indicator 402 may be an illustration of an airplane. In some instances, the user interface 400 can include financial parameter indicators that may indicate each of the financial parameters that are being used in the property match analysis. For example, the financial parameter indicators may include text indicating a credit score associated with acquiring a person associated with the property match analysis.

The property elements 404 are indications that indicate the real estate properties that meet the requirements of the proximity parameters that are being used in the property match analysis. In some instances, the property elements 404 may correspond with the real estate properties included in the property match data generated in step 308, discussed above. As illustrated, a first of the property elements 404 can include content related to a first real estate property that meets the requirements of the proximity parameters such as descriptions of the first real estate property, photographs of the first real estate property, videos of the first real estate property or other elements that relate to the first real estate property. As illustrated, a second of the property elements 404 can include content related to a second real estate property that meets the requirements of the proximity parameters such as descriptions of the second real estate property, photographs of the second real estate property, videos of the second real estate property, or other elements that relate to the second real estate property. In some instances, the property elements 404 are indications that indicate the real estate properties that meet the requirements of the financial parameters that are being used in the property match analysis. In some instances, the property elements 404 are indications that indicate the real estate properties that meet the requirements of both the proximity parameters and the financial parameters.

In some instance, the property elements 404 may include a variety of other text-based, color based, or symbol based indicators indicative that the real estate properties meet the requirements of the proximity parameters. In some instances, the property elements 404 may vary based on how closely the real estate properties meet the requirements of the proximity parameters that are being used in the property match analysis. For example, the property elements 404 may include one or more of a color-coded indicator (e.g., a red indicator indicates that the real estate properties do not meet the requirements of the proximity parameters, a yellow indicator indicates that the real estate properties meet some of the requirements of the proximity parameters, a green indicator indicates that the real estate properties meet the requirements of the proximity parameters, etc.), a predetermined shape-based symbol (e.g., a plus sign next to the property elements 404 for each of the proximity parameters that the real estate properties meet to indicate a number of the proximity parameters that the real estate properties meet, a minus sign next to the property elements 404 for each of the proximity parameters that the real estate properties do not meet to indicate a number of the proximity parameters that the real estate properties do not meet, etc.), or any other suitable type of indicator. In some instances, the property elements 404 may include a variety of other text-based, color based, or symbol based indicators indicative that the real estate properties meet the requirements of the financial parameters.

The property information elements 406 may indicate additional information related to the real estate properties associated with the property elements 404. For example, the property information elements 406 may include addresses of the real estate properties, valuations of the real estate properties, information related to a sale of the real estate properties (e.g., a time that the real estate properties have been on the market, a trend in a sale price of the real estate properties, etc.).

The property actionable items 408 may be associated with the real estate properties associated with the property elements 404. In some instances, the user may select one of the property actionable items 408 to receive additional information related to the real estate properties. For example, in some instances, the property actionable item 408 may allow for the processing circuit to generate and provide a third party website related to the real estate properties to the user, to link the user to a different application to provide additional information related to the real estate properties, provide information related to a loan associated with the real estate properties, or take other actions based on the real estate properties associated with the property elements 404.

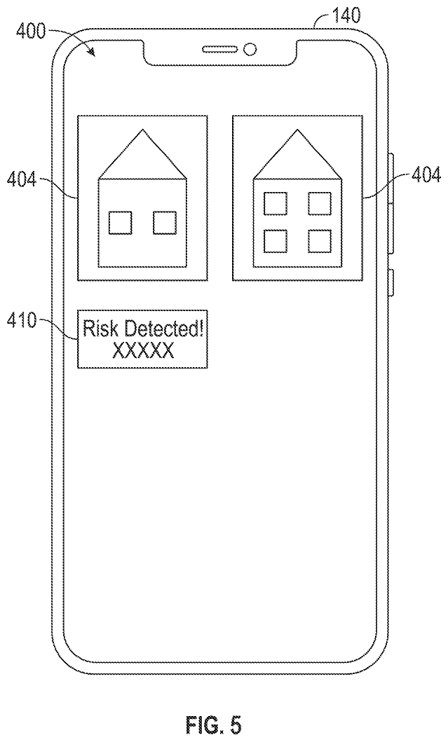

Referring now to FIG. 5, an illustration of a configuration of the user interface 400 on the user device 140 is shown. As illustrated, the user interface 400 includes the property elements 404 and a risk indicator 410. The risk indicator 410 may be associated with one or more of the real estate properties associated with the property elements 404. For example, the risk indicator 410 may indicate that one of the real estate properties corresponds to an environmental risk or a social risk. In some embodiments, the risk indicator 410 may include a variety of other text-based, color based, or symbol based indicators indicative of the risk associated with the real estate properties. For example, the risk indicator 410 may include an illustration of a hurricane if the real estate property is associated with a risk of hurricanes or an illustration of a police car if the real estate property is associated with a risk of high crime.

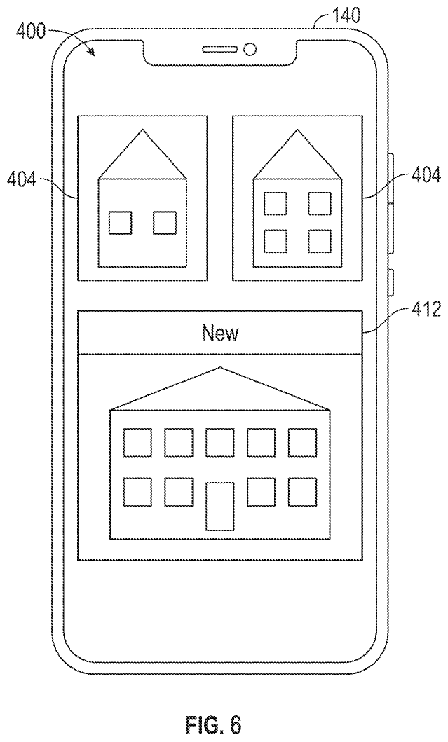

Referring now to FIG. 6, an illustration of a configuration of the user interface 400 on the user device 140 is shown. As illustrated, the user interface 400 includes the property elements 404 and a new property element 412. The new property element 412 is an indication that indicates a new real estate property that meets the requirements of the proximity parameters that are being used in the property match analysis and was not included in the original property match analysis. The new property element 412 may include any of the content or the indicators described relative to the property elements 404. In some instances, the new property element 412 may include an indication that the new real estate element was not included in the original property match analysis. For example, the new property element 412 may include the text “New” to indicate that the new real estate property associated with the new property element 412 was not included in the original property match analysis. In some instances, the new property element 412 may be an indication that indicates a predicted real estate property that is predicted to meet the requirements of the proximity parameters in the future.

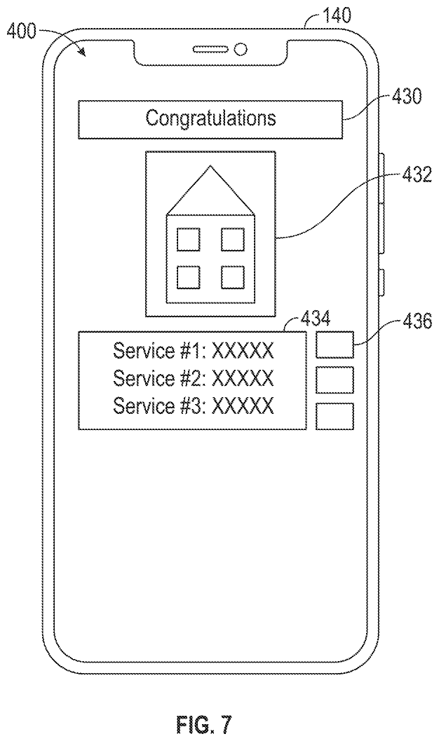

Referring now to FIG. 7, an illustration of a configuration of the user interface 400 on the user device 140 is shown. As illustrated, the user interface 400 includes a purchase notification 430, a property element 432, a plurality of service indicators 434, and a plurality of service trackers 436. The purchase notification 430 may be configured to notify a user of the user device that a person has acquired a property. In some embodiments, the purchase notification 430 may include a variety of other text-based, color based, or symbol based indicators indicative that the person has acquired the property. For example, the purchase notification 430 may include the text “Congratulations” to acknowledge that the person has acquired the property.

The property element 432 may be an element related to the property acquired by the person. The property element 432 include any of the content or the indicators described relative to the property elements 404. The service indicators 434 are indications that indicate services associated with the property acquired by the person. For example, the services associated with the property may include a garbage service, a gas service, an electricity service, etc. As illustrated, the service indicators 434 can include content related to the services associated with the property such as descriptions of the services, photographs of the services, videos of the services, or other elements that relate to the services. For example, one of the service indicators related to a refuse service may include the word “Garbage” or an illustration of a refuse vehicle. The service trackers 436 are indications that the person that acquired the property has registered for the services indicated by the service indicators 343. For example, the service trackers 436 may be check boxes and the service trackers 436 may include a check mark that appear inside of the check boxes after the person has registered for the services indicated by the service indicators 434.

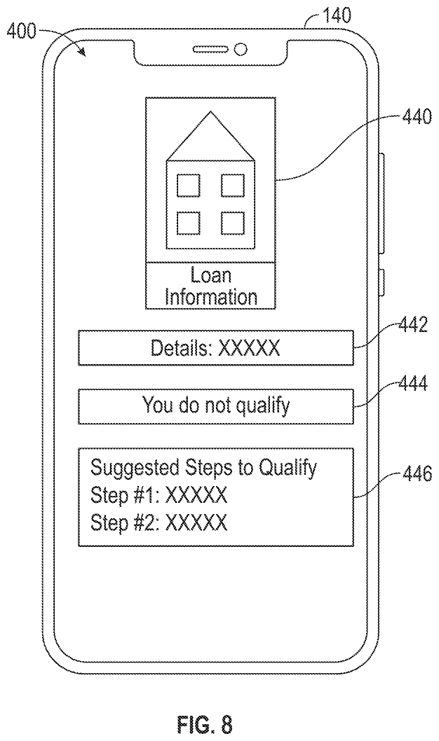

Referring now to FIG. 8, an illustration of a configuration of the user interface 400 on the user device 140 is shown. As illustrated, the user interface 400 includes a loan information element 440, a loan term element 442, a loan status indication 444, and a plurality of suggestion instructions 446. The loan information element 440 may be an element related to a loan associated with one of the real estate properties included in the property match data generated in step 308, discussed above. The loan information element 440 may include any of the content or the indicators described relative to the property elements 404. For example, the loan information element 440 may include content related to the one of the real estate properties included in the property match data. The loan term element 442 may include detailed content associated with the loan associated with the one of the real estate properties. For example, the loan term element 442 may include text detailing the terms of the loan associated with the real estate property such as a length of the loan or an interest rate associated with the loan.

The loan status indication 444 may indicate if the person associated with the property match analysis qualifies for the loan associated with the one of the real estate properties. As illustrated, the loan status indication 444 can include text or other content corresponding to if the person associated with the property match analysis qualifies for the loan. For example, the loan status indication 444 may include a variety of text-based, color based, or symbol based indicators indicative if the person associated with the property match analysis qualifies for the loan. In some instances, the status indication may vary depending on if the person qualifies for the loan. For example, the loan status indication 444 may include one or more of a color-coded indicator (e.g., a red indicator indicates that the person does not qualify for the loan, a green indicator indicates that the person qualifies for the loan, etc.) or any other suitable type of indicator.

If the person does not qualify for the loan, the suggestion instructions 446 may include steps that the person can take in order to qualify for the loan. For example, the suggestion instructions 446 may include a step to hold a job for a predetermined amount of time or a step to decrease a debt to income ration below a predetermined threshold. In some instances, the suggestion instructions 446 may include multiple steps that the person can take in order to qualify for the loan.

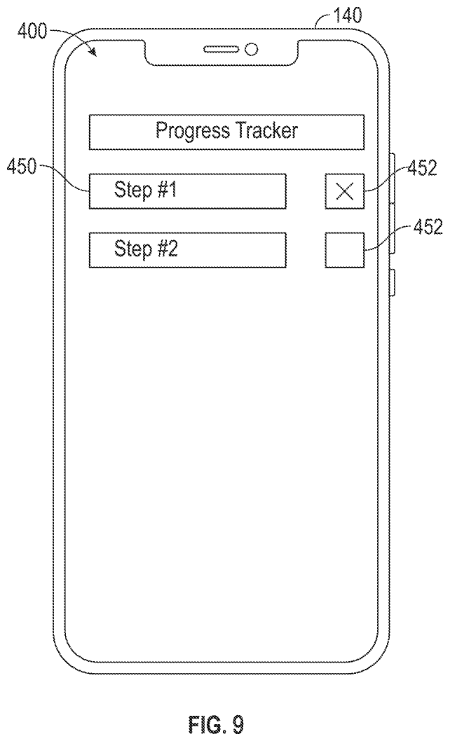

Referring now to FIG. 9, an illustration of a configuration of the user interface 400 on the user device 140 is shown. As illustrated, the user interface 400 includes a plurality of steps 450, a step completed marker 452, and a step uncompleted marker 454. The plurality of steps 450 may include the steps that the person can take in order to qualify for the loan as described relative to suggestion instructions 446. The step completed marker 452 may be associated with one of the plurality of steps 450 and may indicate that the person completed one of the steps that the person can take in order to qualify for the loan. The step uncompleted marker 454 may be associated with one of the plurality of steps 450 and may indicate that that the person has not completed one of the steps that the person can take in order to qualify for the loan.

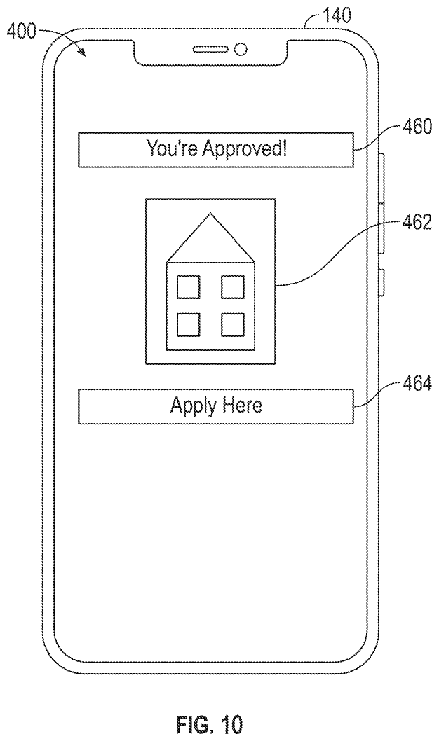

Referring now to FIG. 10, an illustration of a configuration of the user interface 400 on the user device 140 is shown. As illustrated, the user interface 400 includes a loan status notification 460, a property element 462, and a loan actionable item 464. The loan status notification 460 may indicate if the person associated with the property match analysis qualifies for the loan associated with the one of the real estate properties. The loan status notification 460 may include any of the elements as described relative to loan status indication 444. The property element 462 may include any of the elements as described relative to the property elements 404. The loan actionable item 464 may be associated with the loan associated with the one of the real estate properties. In some instances, the user may select the loan actionable item 464 to apply for the loan associated with the one of the real estate properties.

It should be understood that no claim element herein is to be construed under the provisions of 35 U.S.C.§ 112(f) unless the element is expressly recited using the phrase “means for.”

As used herein, the term “circuitry” may include hardware structured to execute the functions described herein. In some embodiments, each respective “circuit” may include machine-readable media for configuring the hardware to execute the functions described herein. The circuit may be embodied as one or more circuitry components including, but not limited to, processing circuitry, network interfaces, peripheral devices, input devices, output devices, sensors, etc. In some embodiments, a circuit may take the form of one or more analog circuits, electronic circuits (e.g., integrated circuits (IC), discrete circuits, system on a chip (SOCs) circuits, etc.), telecommunication circuits, hybrid circuits, and any other type of “circuit.” In this regard, the “circuit” may include any type of component for accomplishing or facilitating achievement of the operations described herein. For example, a circuit as described herein may include one or more transistors, logic gates (e.g., NAND, AND, NOR, OR, XOR, NOT, XNOR, etc.), resistors, multiplexers, registers, capacitors, inductors, diodes, wiring, and so on).

The “circuit” may also include one or more processors communicatively coupled to one or more memory or memory devices. In this regard, the one or more processors may execute instructions stored in the memory or may execute instructions otherwise accessible to the one or more processors. In some embodiments, the one or more processors may be embodied in various ways. The one or more processors may be constructed in a manner sufficient to perform at least the operations described herein. In some embodiments, the one or more processors may be shared by multiple circuits (e.g., circuit A and circuit B may include or otherwise share the same processor which, in some example embodiments, may execute instructions stored, or otherwise accessed, via different areas of memory).

Alternatively, or additionally, the one or more processors may be structured to perform or otherwise execute certain operations independent of one or more co-processors. In other example embodiments, two or more processors may be coupled via a bus to enable independent, parallel, pipelined, or multi-threaded instruction execution. Each processor may be provided as one or more general-purpose processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor, etc.), microprocessor, etc. In some embodiments, the one or more processors may be external to the apparatus, for example the one or more processors may be a remote processor (e.g., a cloud-based processor). Alternatively, or additionally, the one or more processors may be internal and/or local to the apparatus. In this regard, a given circuit or components thereof may be disposed locally (e.g., as part of a local server, a local computing system, etc.) or remotely (e.g., as part of a remote server such as a cloud-based server). To that end, a “circuit” as described herein may include components that are distributed across one or more locations.

Example systems and devices in various embodiments might include a processing unit, a system memory, and a system bus that couples various system components including the system memory to the processing unit. Each memory device may include non-transient volatile storage media, non-volatile storage media, non-transitory storage media (e.g., one or more volatile and/or non-volatile memories), etc. In some embodiments, the non-volatile media may take the form of ROM, flash memory (e.g., flash memory such as NAND, 3D NAND, NOR, 3D NOR, etc.), EEPROM, MRAM, magnetic storage, hard discs, optical discs, etc. In other embodiments, the volatile storage media may take the form of RAM, TRAM, ZRAM, etc. Combinations of the above are also included within the scope of machine-readable media. In this regard, machine-executable instructions include, for example, instructions and data which cause a general purpose computer, special purpose computer, or special purpose processing machines to perform a certain function or group of functions. Each respective memory device may be operable to maintain or otherwise store information relating to the operations performed by one or more associated circuits, including processor instructions and related data (e.g., database components, object code components, script components, etc.), in accordance with the example embodiments described herein.

It should also be noted that the term “input devices,” as described herein, may include any type of input device including, but not limited to, a keyboard, a keypad, a mouse, joystick, or other input devices performing a similar function. Comparatively, the term “output device,” as described herein, may include any type of output device including, but not limited to, a computer monitor, printer, facsimile machine, or other output devices performing a similar function.

Any foregoing references to currency or funds are intended to include fiat currencies, non-fiat currencies (e.g., precious metals), and math-based currencies (often referred to as cryptocurrencies). Examples of math-based currencies include Bitcoin, Litecoin, Dogecoin, and the like.

It should be noted that although the diagrams herein may show a specific order and composition of method steps, it is understood that the order of these steps may differ from what is depicted. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative embodiments. Accordingly, all such modifications are intended to be included within the scope of the present disclosure as defined in the appended claims. Such variations will depend on the machine-readable media and hardware systems chosen and on designer choice. It is understood that all such variations are within the scope of the disclosure. Likewise, software and web implementations of the smart table system may be accomplished with standard programming techniques with rule-based logic and other logic to accomplish the various database searching steps, correlation steps, comparison steps and decision steps.

The foregoing description of embodiments has been presented for purposes of illustration and description. It is not intended to be exhaustive or to limit the disclosure to the precise form disclosed, and modifications and variations are possible in light of the above teachings or may be acquired from this disclosure. The embodiments were chosen and described to explain the principals of the disclosure and its practical application to enable one skilled in the art to utilize the various embodiments and with various modifications as are suited to the particular use contemplated. Other substitutions, modifications, changes, and omissions may be made in the design, operating conditions, and arrangement of the embodiments without departing from the scope of the present disclosure as expressed in the appended claims.

What is claimed is:

1. A system comprising:
a processing circuit comprising memory and one or more processors, the processing circuit configured to:
receive transaction data of a person, wherein the transaction data relates to a transaction associated with a category;
determine, based on the transaction data, proximity parameters of the person, wherein the proximity parameters correspond to a proximity to at least one merchant belonging to the category associated with the transaction;
receive property data relating to real estate properties;
model the property data with the proximity parameters to generate property match data for the person, wherein the property match data corresponds to at least one of the real estate properties that include the proximity to the at least one merchant belonging to the category associated with the transaction; and
generate and provide, to a graphical user interface (GUI) of a user device, an interface corresponding to the property match data.

2. The system of claim 1, wherein the processing circuit is further configured to:
receive financial data of the person, wherein the financial data corresponds to financial factors of the person;
determine, based on the financial data, financial parameters of the person, wherein the financial parameters correspond to a maximum property value the person can afford;
model the property data with the proximity parameters and the financial parameters to generate the property match data for the person, wherein the property match data corresponds to at least one of the real estate properties that has a valuation less than the maximum property value and includes the proximity to the at least one merchant belonging to the category associated with the transaction; and
update the interface corresponding to the property match data.

3. The system of claim 2, wherein the processing circuit is further configured to:
generate loan data corresponding to a loan related to at least one of the real estate properties included in the property match data;
determine, based on the financial data and the loan data, that the person does not qualify for the loan;
model the financial data with the loan data to generate suggestion data, wherein the suggestion data comprises a process for the person to qualify for the loan; and
generate and provide, to the GUI of the user device, a suggestion interface corresponding to the suggestion data, wherein the suggestion interface comprises a plurality of steps in the process for the person to qualify for the loan.

4. The system of claim 3, wherein the processing circuit is further configured to:
determine that the person has completed at least one of the plurality of steps in the process for the person to qualify for the loan; and
update the suggestion interface to include one or more elements, wherein the one or more elements correspond to the at least one of the plurality of steps in the process for the person to qualify for the loan that the person has completed.

5. The system of claim 3, wherein the processing circuit is further configured to:
determine that the person has completed at least one of the plurality of steps in the process for the person to qualify for the loan;
receive the financial data relating to the person;
determine, based on the financial data and the loan data, that the person does qualify for the loan; and
generate and provide, to the GUI of the user device, an approval notification, wherein the approval notification comprises a notice that the person qualifies for the loan.

6. The system of claim 1, wherein the processing circuit is further configured to:
determine, based on the property data, that at least one of the real estate properties corresponding to the property match data is associated with a risk; and
generate and provide, to the GUI of the user device, an alert corresponding to the at least one of the real estate properties and the risk, wherein the risk is associated with at least one environmental factor or social factor.

7. The system of claim 1, wherein the processing circuit is further configured to:
receive an update to the property data relating to new real estate properties, wherein the new real estate properties are not originally included in the property data;
model the property data with the proximity parameters to generate the property match data for the person; and
update the interface corresponding to the property match data.

8. The system of claim 1, wherein the processing circuit is further configured to:
receive an indication that the person has acquired a property;
determine, based on the property data, services relating to the property; and
generate and provide, to the GUI of the user device, a notification interface corresponding to the services relating to the property.

9. The system of claim 8, wherein the services include at least one of a waste service, an electric service, or a water service.

10. A method comprising:
receiving, by a processing circuit, transaction data of a person, wherein the transaction data relates to a transaction associated with a category;
determining, based on the transaction data, proximity parameters of the person, wherein the proximity parameters correspond to a proximity to at least one merchant belonging to the category associated with the transaction;
receiving property data relating to real estate properties;
modeling the property data with the proximity parameters to generate property match data for the person, wherein the property match data corresponds to at least one of the real estate properties that include the proximity to the at least one merchant belonging to the category associated with the transaction; and
generating and providing, to a graphical user interface (GUI) of a user device, an interface corresponding to the property match data.

11. The method of claim 10, further comprising:
receiving financial data of the person, wherein the financial data corresponds to financial factors of the person;
determining, based on the financial data, financial parameters of the person, wherein the financial parameters correspond to a maximum property value the person can afford;
modeling the property data with the proximity parameters and the financial parameters to generate the property match data for the person, wherein the property match data corresponds to at least one of the real estate properties that has a valuation less than the maximum property value and includes the proximity to the at least one merchant belonging to the category associated with the transaction; and
updating the interface corresponding to the property match data.

12. The method of claim 11, further comprising:
generating loan data corresponding to a loan related to at least one of the real estate properties included in the property match data;
determining, based on the financial data and the loan data, that the person does not qualify for the loan;
modeling the financial data with the loan data to generate suggestion data, wherein the suggestion data comprises a process for the person to qualify for the loan; and
generating and providing, to the GUI of the user device, a suggestion interface corresponding to the suggestion data, wherein the suggestion interface comprises a plurality of steps in the process for the person to qualify for the loan.

13. The method of claim 12, further comprising:
determining that the person has completed at least one of the plurality of steps in the process for the person to qualify for the loan;
receiving the financial data relating to the person;
determining, based on the financial data and the loan data, that the person does qualify for the loan; and
generating and providing, to the GUI of the user device, an approval notification, wherein the approval notification comprises a notice that the person qualifies for the loan.

14. The method of claim 10, further comprising:
determining, based on the property data, that at least one of the real estate properties corresponding to the property match data is associated with a risk; and
generating and providing, to the GUI of the user device, an alert corresponding to the at least one of the real estate properties and the risk, wherein the risk is associated with at least one environmental factor or social factor.

15. The method of claim 10, further comprising:
receiving an update to the property data relating to new real estate properties, wherein the new real estate properties are not originally included in the property data;
modeling the property data with the proximity parameters to generate the property match data for the person; and
updating the interface corresponding to the property match data.

16. The method of claim 10, further comprising:
receiving an update to the property data relating to new real estate properties, wherein the new real estate properties are not originally included in the property data;
modeling the property data with the proximity parameters to generate the property match data for the person; and
updating the interface corresponding to the property match data.

17. The method of claim 10, further comprising:
receiving an indication that the person has acquired a property;
determining, based on the property data, services relating to the property; and
generating and providing, to the GUI of the user device, a notification interface corresponding to the services relating to the property.

18. The method of claim 17, wherein the services include at least one of a waste service, an electric service, or a water service.

19. A non-transitory computer-readable storage medium having instructions stored thereon that, when executed by one or more processing circuits, cause the one or more processing circuits to perform operations comprising:
receiving, by the one or more processing circuits, transaction data of a person, wherein the transaction data relates to a transaction associated with a category;
receiving financial data of the person, wherein the financial data corresponds to financial factors of the person;
determining, based on the transaction data, proximity parameters of the person, wherein the proximity parameters correspond to a proximity to at least one merchant belonging to the category associated with the transaction;
determining, based on the financial data, financial parameters of the person, wherein the financial parameters correspond to a maximum property value the person can afford;
receiving property data relating to real estate properties;
modeling the property data with the proximity parameters and the financial parameters to generate the property match data for the person, wherein the property match data corresponds to at least one of the real estate properties that has a valuation less than the maximum property value and includes the proximity to the at least one merchant belonging to the category associated with the transaction; and
generating and providing, to a graphical user interface (GUI) of a user device, an interface corresponding to the property match data.

20. The non-transitory computer-readable storage medium of claim 19, wherein the operations further comprise:
generating loan data corresponding to a loan related to at least one of the real estate properties included in the property match data;
determining, based on the financial data and the loan data, that the person does not qualify for the loan;
modeling the financial data with the loan data to generate suggestion data, wherein the suggestion data comprises a process for the person to qualify for the loan; and
generating and providing, to the GUI of the user device, a suggestion interface corresponding to the suggestion data, wherein the suggestion interface comprises a plurality of steps in the process for the person to qualify for the loan.
